(19) United States
(12) Patent Application Publication
(10) Pub. No.: US 2021/0068515 A1
(43) Pub. Date: Mar. 11, 2021

(54) ARTICLE FOR DECORATING A PERSON'S SKIN, LIPS OR NAIL, FIXING AGENT FOR SUCH AN ARTICLE AND METHOD OF DECORATING THE SKIN, LIPS OR NAIL

(71) Applicant: L V M H RECHERCHE, SAINT JEAN DE BRAYE (FR)

(72) Inventors: Marc CHEVALIER, FRANCONVILLE (FR); Jean-François TRANCHANT, MARIGNY-LES USAGES (FR)

(73) Assignee: L V M H RECHERCHE, SAINT JEAN DE BRAYE (FR)

(21) Appl. No.: 16/772,062

(22) PCT Filed: Dec. 14, 2018
(86) PCT No.: PCT/FR2018/053314

§ 371 Date: Jun. 11, 2020

(30) Foreign Application Priority Data
Dec. 14, 2017 (FR) 17 62184

(51) Int. Cl. A45D 29/00; A45D 44/00; A44C 15/00; B44C 1/10

(52) U.S. Cl. CPC A45D 29/001; A45D 44/00; A45D 2200/25; B44C 1/105; A45D 2029/005; A44C 15/0005

(57) ABSTRACT

The article for decorating a person's skin, lips or nail comprises a decorative element to be transferred by means of a fixing agent comprising a pressure-sensitive adhesive polymer and a solvent. The article comprises: a decorative layer to be transferred, the decorative layer comprising the decorative element, the decorative layer having a first external surface and a second external surface; a support film of the decorative layer, said support film being removably fixed to the first external surface of said decorative layer; and a base layer forming a barrier for limiting migration of the pressure-sensitive adhesive polymer, the base layer being resistant to the solvent.

### FIELD OF THE INVENTION

The invention relates to articles for decorating the human body, and in particular to temporary decorative elements to be applied to the skin or nails.

### BACKGROUND OF THE INVENTION

Numerous products exist for application to the skin or nails, intended to temporarily embellish, cover, conceal, or else enhance a body part of a person. Such types of makeup are found in several forms (powder, cream, glitter), packaged in bottles with or without applicators.

Temporary tattoos to apply to the skin or nails also exist, which are in the form of a decoration with predetermined contours supported by a sheet. The decoration is transferred to the skin or nails by applying the sheet at the location where one wishes to position the tattoo (the face of the sheet bearing the decoration being positioned against the skin or nail) and the external face of the sheet is moistened in order to peel the decoration off from its support in order to transfer it.

Decorations of the “sticker” type, to be applied to the skin or nails, are also found: Such decorations are in the form of self-adhesive images with predefined contours that must be cut to fit the shape and size of a nail, for example. The result obtained with such stickers is imprecise and not always esthetic, for example not covering the entire surface to be decorated.

In addition, the devices described above have the disadvantage of being difficult to remove.

Patent application FR 2 999 063 describes an article for decorating a person's skin or nail, comprising a decorative element to be applied to the skin or to at least one nail of a person, said decorative element comprising a decoration to be at least partially transferred to the skin or nail of a person, said decoration comprising at least one decorative layer, having a first external surface and a second external surface and a support film of said decoration, said support film being removably fixed to the first external surface of said decorative layer. The article also comprises a fluid product that can be applied to the skin by means of an applicator, the fluid product having the special feature of becoming sticky while drying.

Such an article does not enable precise results to be obtained, and is even capable of damaging the decoration by partially dissolving it on contact.

In addition, document DE 33 37 458 A describes an article for decorating the skin or a nail, whose application requires, for example, a source of radiation or heat, or a pressure-sensitive adhesive. According to this document, this pressure-sensitive adhesive may be applied to the nail, prior to the application of a decorative layer.

### SUMMARY OF THE INVENTION

The invention aims to offer an article for decorating a person's skin, lips or nail, which enables a precise decorative result to be obtained, with no shape limitation, and that is simple to implement.

For this purpose, the invention proposes an article for decorating a person's skin, lips or nail, comprising at least one decorative element to be transferred to the skin, lips or at least one nail of a person by means of a fixing agent comprising at least one pressure-sensitive adhesive polymer and at least one solvent, the article comprising:
a decorative layer to be at least partially transferred to a person's skin, lips or nail, said decorative layer comprising said at least one decorative element, said decorative layer having a first external surface and a second external surface,
a support film of said decorative layer, said support film being removably fixed to the first external surface of said decorative layer,
a base layer forming a barrier for limiting or even preventing migration of the at least one pressure-sensitive adhesive polymer, said base layer being resistant to said at least one solvent.

Advantageously the article according to the invention thus has a decorative layer that is transferred with the aid of a fixing agent. Advantageously, the article comprises a base layer, between the decorative layer and the fixing agent, for limiting or even preventing migration of the pressure-sensitive adhesive polymer(s) of the fixing agent, the decorative layer being resistant to the solvent(s) of the fixing agent. Therefore, the adhesiveness of the pressure-sensitive adhesive polymer(s), used between the decorative layer and the skin, lips or nail, is not altered by the migration of this or these polymer(s).

The base layer can also prevent the solvent from damaging the decorative layer.

According to preferred embodiments, the article according to the invention may comprise one or more of the following characteristics, taken alone or in combination:
the article comprises a separation layer between the decorative layer and the support film, said separation layer being intended to enable the separation of the decorative layer and the support film, once the decorative layer has been transferred to a person's skin, lips or at least one nail, by means of said fixing agent;
the base layer comprises at least SiO2 and an acrylic resin, in particular an acrylate copolymer;
the decorative layer comprises several superimposed sublayers;
the decorative layer comprises at least one metallic layer, in particular a layer of aluminum, the metallic layer being, for example, deposited by chemical vapor deposition;
the decorative layer comprises at least one layer of acrylate copolymer and of colored pigments and/or of pearlescent powder and/or a decorative layer with a metallic effect;
the support film is curved, in particular with a radius of curvature different from that of the area onto which the decorative layer is intended to be transferred;
the support film is flat;
the support film is transparent, translucent or opaque, in particular of PET;
the decorative element comprises at least one among a pattern in two or three dimensions, or an effect imitating three dimensions, or imitating a fabric, a particle effect, a metal, or a decoration providing optical illusions according to its orientation relative to a light source;
only a portion of the decorative layer is intended to be transferred to a person's skin, lips or at least one nail, to the location where the fixing agent has been applied beforehand; and
the thickness of the base layer is less than 20 μm, preferably less than 15 μm.

According to another aspect, the invention relates to a fixing agent for transferring the decorative layer of an article as described above in all its combinations, onto a person's skin, lips or nail, comprising at least one pressure-sensitive adhesive polymer and at least one solvent.

Preferably, the fixing agent comprises at least one among the following products:
DOW CORNING® MG-2402 SILICONE ADHESIVE; and/or
DOW CORNING® BIO-PSA 7-4602 SILICONE ADHESIVE.

The fixing agent may comprise, in percentages by weight:
40 to 70% DOW CORNING® MG-2402 SILICONE ADHESIVE;
1 to 15% DOW CORNING® BIO-PSA 7-4602 SILICONE ADHESIVE; and
q.s. solvent to 100%.

Alternatively, the fixing agent comprises, in percentages by weight:
50 to 60% DOW CORNING® MG-2402 SILICONE ADHESIVE;
4 to 9% DOW CORNING® BIO-PSA 7-4602 SILICONE ADHESIVE; and

q.s. solvent to 100%.

According to another alternative, the fixing agent comprises, in percentages by weight:
54.5% DOW CORNING® MG-2402 SILICONE ADHESIVE;
9% DOW CORNING® BIO-PSA 7-4602 SILICONE ADHESIVE;

and
36.4% solvent.

The fixing agent may comprise in percentages by weight:
52% DOW CORNING® MG-2402 SILICONE ADHESIVE;
8% DOW CORNING® BIO-PSA 7-4602 SILICONE ADHESIVE; and
40% solvent.

According to another alternative, the fixing agent comprises in percentages by weight:
54% DOW CORNING® MG-2402 SILICONE ADHESIVE;
7% DOW CORNING® BIO-PSA 7-4602 SILICONE ADHESIVE; and
39% solvent.

Alternatively, the fixing agent comprises in percentages by weight:
60% DOW CORNING® MG-2402 SILICONE ADHESIVE;
4% DOW CORNING® BIO-PSA 7-4602 SILICONE ADHESIVE; and
36% solvent.

The solvent may contain, or preferably be, XIAMETER® PMX-200 SILICONE FLUID 0.65 CS.

According to another aspect, an object of the invention is a kit for decorating a person's skin, lips or nail, comprising at least one article such as described above, in all its combinations, and at least one container containing a fixing agent as described above in all its combinations.

The decorating kit may also comprise a fixing agent application element, for example a brush, the application element preferably being suitable for closing an opening of the container containing the fixing agent in order to close off said container.

The decorating kit may also comprise an applicator, for example an applicator of flocked silicone, capable of smoothing over said at least one article onto a person's skin, lips or nail.

According to another aspect, the invention relates to a method of decorating a person's nail, skin or lips, by means of an article such as described above in all its combinations, or forming part of a decorating kit such as described above in all its combinations, comprising steps consisting of:
i) Applying a layer of fixing agent such as described above in all its combinations, or forming part of said decorating kit, onto the part to be decorated;
ii) Allowing the solvent(s) of the fixing agent to evaporate;
iii) Affixing the article onto the part to be decorated;
iv) Applying pressure on the article; and
v) Removing the support film from the article.

In step i), a layer of fixing agent with a thickness equal to or greater than 25 μm, preferably equal to or greater than 30 μm and/or less than 75 μm, preferably less than 50 μm, may be applied.

Step i) may be carried out by means of an application element, the application element preferably being a brush.

In step iv), the article is smoothed over, preferably with an applicator of flocked silicone and/or until the decorative layer detaches from the support film.

In step v), only a portion of the decorative layer is transferred, where a layer of fixing agent has previously been applied in step i).

### BRIEF DESCRIPTION OF THE DRAWINGS

Other features and advantages of the invention will appear upon reading the following detailed description, given regarding the drawings in which:

FIG. 1 is a schematic perspective view of an article for decorating a person's nail, lips or skin;

FIG. 2 is an enlargement of detail II of FIG. 1;

FIG. 3 illustrates the application of a fixing agent for the article of FIGS. 1 and 2, onto a person's nail;

FIG. 4 illustrates the application of the article of FIGS. 1 and 2, onto a person's nail;

FIG. 5 illustrates the result of the application of FIG. 4, onto a person's nail;

FIG. 6 illustrates the article of FIGS. 1 and 2 after the application of FIG. 4;

FIG. 7 illustrates the application of a fixing agent for the article of FIGS. 1 and 2, onto a person's eyelid;

FIG. 8 illustrates the application of the article of FIGS. 1 and 2, onto a person's eyelid;

FIG. 9 represents the result of the application of the article of FIGS. 1 and 2, onto a person's eyelid;

FIG. 10 illustrates the article of FIGS. 1 and 2 after the application of FIG. 8;

FIG. 11 schematically represents the application of a fixing agent for the article of FIGS. 1 and 2, onto the skin of a person's shoulder;

FIG. 12 illustrates the application of the article of FIGS. 1 and 2, onto the skin of a person's shoulder;

FIG. 13 represents the result of the application of the article of FIGS. 1 and 2, onto the skin of a person's shoulder; and

FIG. 14 represents the article of FIGS. 1 and 2 after the application of FIG. 12.

### DETAILED DESCRIPTION

In the following description, the terms “lower,” “upper,” “top,” “bottom,” etc. are used in reference to the drawings, for greater clarity. They are not to be understood as being limitations on the scope of the invention.

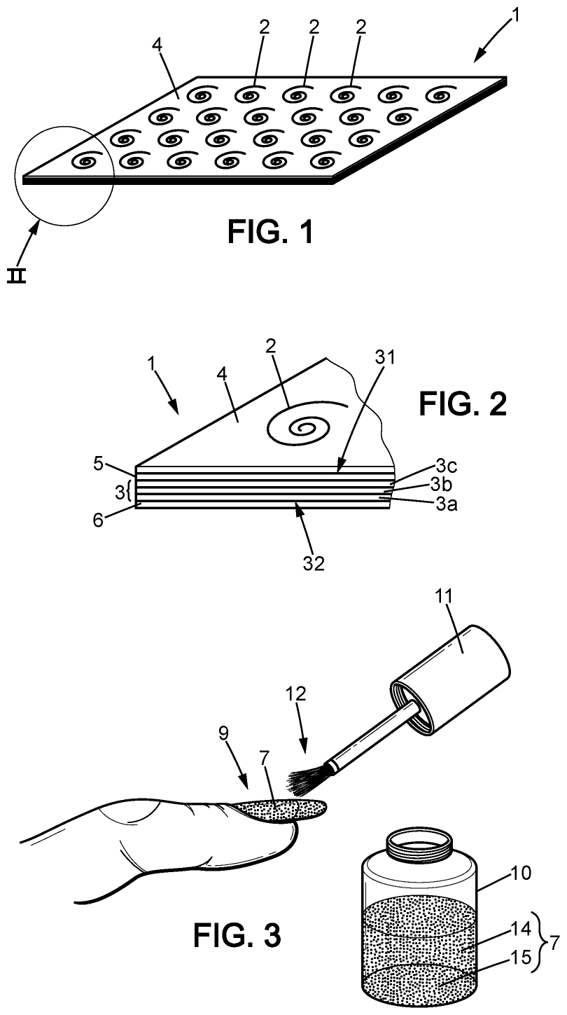

FIG. 1 shows an exemplary article 1 for decorating a person's nail, lips, eyelid or, more generally, skin. In the example illustrated, article 1 is presented in the form of a flexible sheet, here substantially rectangular.

By way of example, the sheet has a smaller side measuring at least 10 cm, even at least 1 cm, indeed even at least 0.1 cm. Preferably, the smallest side measures between 0.1 cm and 30 cm, even between 0.1 cm and 5 cm, indeed even between 0.1 cm and 1 cm. The sheet preferably has a surface area measuring at least 0.5 cm², even at least 1 cm², indeed even at least 10 cm². Preferably, the sheet has a surface area measuring between 0.5 cm² and 100 cm², even between 10 cm² and 100 cm².

More generally, the article can have dimensions enabling several uses, corresponding to distinct portions of the article transferred one after the other. For example, a same article can have dimensions enabling more than one nail to be decorated, in particular two, five or ten nails, by transferring distinct portions of the article onto each of the nails.

Of course, the sheet may have other dimensions and/or a different shape.

In particular, article 1 may be present in the form of a strip in which one planar dimension, the length, is markedly longer than the other, the width. In particular, the length of the strip may be at least five times, preferably at least ten times, still more preferably at least twenty times, longer than the width of the strip. Again, a strip may advantageously enable more than one nail to be decorated, notably at least two nails, in particular five or ten nails.

In the following, the description more particularly relates to the application of article 1 in order to decorate a person's nail 9, by transferring at least one decorative element 2 from article 1 to nail 9, by means of a fixing agent comprising at least one pressure-sensitive adhesive polymer and at least one solvent. However, unless otherwise stated, what is stated also applies to the application of article 1 onto a person's lips, eyelids or, more generally, skin.

Decorative element 2 may take any form accessible to the person skilled in the art. In particular, it may be a color, solid or not, one or more color gradients, a pattern or several patterns, repeated regularly or not on article 1. Decorative element 2 may be an imitation of a three-dimensional pattern, a metallic effect, a pattern, in particular an optical illusion, the appearance thereof varying according to the angle of incidence of the light on this pattern. Decorative element 2 may be a pattern imitating glitter, fabric or a particle effect. Decorative element 2 may also enable a sensory effect such as the feel of velvet or a raised effect to be obtained. The pattern may, in particular, be a character, an abbreviation, a landscape, a monument, a geometric shape or a brand logo. Decorative element 2 may be a combination of the decorative elements indicated above. In this particular case, decorative element 2 may be considered to be a composite decoration.

In the example illustrated, decorative element 2 comprises, in particular, a geometric pattern in the form of a regularly repeated spiral.

According to the example illustrated in FIG. 2, article 1 comprises four layers 3, 4, 5, 6 superimposed on one another.

A first of these layers 3-6 is a decorative layer 3. This is the layer to be at least partially transferred onto a person's nail in order to decorate it using the decorative element 2. This decorative layer 3 has a first surface 31, called the external surface, intended to be oriented in the direction opposite the nail to be decorated, and a second surface 32, called the internal surface, intended to be oriented in the direction of the nail to be decorated.

In the example illustrated, decorative layer 3 comprises three superimposed sublayers 3a, 3b, 3c. For example, lower sublayer 3a, closest to the nail to be decorated such that it here forms the internal surface 32, is a metallic sublayer. This lower sublayer 3a may be a layer of aluminum. Aluminum sublayer 3a may have been deposited by chemical vapor deposition (CVD). Middle sublayer 3b is, for example, a sublayer in a solid color. Lastly, upper sublayer 3c, farthest from the nail to be decorated such that here it forms the external surface 31, may be a protective sublayer for the lower sublayers. For this purpose, this protective sublayer 3c is, for example, a sublayer of resin, lacquer or a plastic material. Patterns 2 may be embedded in a protective sublayer 3c or may be covered by this protective sublayer 3c. In the latter case, patterns 2 may be drawn on solid color sublayer 3b. Protective sublayer 3c is advantageously translucent or transparent. This protective sublayer 3c essentially aims to prevent direct contact with the other sublayers, which could damage them and make their depiction less esthetic.

Of course, the number of sublayers of decorative layer 3 is not limited to three. In fact, the person skilled in the art understands that this number of layers is to be adapted to the desired decoration, particularly to its complexity and/or to the techniques implemented to produce the decoration. Therefore, decorative layer 3 may in particular comprise at least one sublayer of acrylate copolymer and colored pigments and/or at least one sublayer of pearlescent powder and/or at least one decorative sublayer with a metallic effect.

Decorative layer 3 may be rigid. However, preferably, decorative layer 3 is sufficiently flexible to be applied to a curved or flexible surface such as a person's nail or body part covered with skin, such as an eyelid, shoulder, arm or lips.

Upper layer 4, in FIG. 2, intended to be oriented in the direction opposite the nail to be decorated, is formed of a support film 4 supporting decorative layer 3. This upper layer 4 essentially has the function of protecting decorative layer 3 before the latter is at least partially transferred onto a person's nail. Support film 4 may also provide a certain rigidity to article 1, facilitating its handling before the transfer of decorative layer 3 onto a person's nail and during this transfer of decorative layer 3 onto a person's nail. Also, this support film 4 may be curved, notably with a radius of curvature different from that of the nail onto which the decorative layer 3 is to be transferred. As will be seen below, this facilitates the transfer of decorative layer 3 onto a person's nail. Support film 4 may also be flat; i.e., the film may extend within a plane.

By way of example, support film 4 may be a transparent, translucent or even opaque film. Advantageously, a transparent or translucent film enables the user to see decorative layer 3 and the decorative element 2 that it comprises, before its transfer onto the nail. Support film 4 is therefore, for example, of PET, for polyethylene terephthalate.

Support film 4 may, for example, have a thickness of between 10 μm and 20 μm.

Whether transparent, translucent or opaque, the support film 4 may bear indications such as instructions for transferring the decorative layer. These instructions may comprise diagrams in addition to written indications. Alternatively or in addition, support film 4 may comprise indications relating to removal, i.e. the steps and/or products to be used, preferably, to remove decorative layer 3 transferred onto a person's nail.

When the film is opaque, in particular, support film 4 may bear a reminder of decorative element 2 of the decorative layer. For example, a reminder of the pattern(s) is drawn and/or the color(s) is or are indicated and/or the esthetic effects present in decorative layer 3—such as metallization—are noted on support film 4.

Between support film 4 and decorative layer 3, here article 1 comprises a separation layer 5. This separation layer 5 is intended to enable the separation of decorative layer 3 from the support film, once decorative layer 3 has been transferred to a person's nail, by means of a fixing agent. To do this, separation layer 5 may remain fixed on support film 4, on decorative layer 3, or partially on support film 4 and decorative layer 3. Preferably, separation layer 5 remains essentially fixed to the support film, for a better depiction of the decorative layer. To do this, separation layer 5 advantageously has an adhesiveness (or tack) that is less than that of the fixing agent.

Lastly, article 2 comprises a base layer 6 intended for forming a barrier for limiting or even preventing migration of the pressure-sensitive adhesive polymer(s) of the fixing agent. Base layer 6 is advantageously resistant to the solvent(s) used in the fixing agent, so as to not disintegrate upon contact with this or these solvent(s). Base layer 6 therefore remains effective as a barrier against the migration of the pressure-sensitive adhesive polymer(s) of the fixing agent, even in the event of contact with the solvent(s) of this fixing agent. To achieve this, this base layer 6 comprises, for example, at least SiO2 and an acrylic resin, notably an acrylate copolymer.

Base layer 6 may, in particular, have a thickness of less than 20 μm, even less than 15 μm.

In order to facilitate the transfer of the decorative layer and the identification of the base layer intended to be in contact with the person's nail, this base layer may be colored and/or may comprise writing.

Advantageously, article 2 lacks a layer of adhesive on the surface of base layer 6 oriented to be opposite decorative layer 3.

Article 2 may have a thickness of between 0.01 mm and 0.3 mm, preferably between 0.03 mm and 0.2 mm, particularly for application onto a nail. For application onto the skin, in particular, the thickness of article 2 may be between 0.015 mm and 0.2 mm.

FIGS. 3 to 6 illustrate the transfer of part of decorative layer 3 of article 1 onto a person's nail 9.

As illustrated in FIG. 3, the transfer starts by applying a fixing agent 7 onto the person's nail 9. Fixing agent 7 may be applied by using a brush 12. Still according to this FIG. 3, the gripping part 11 of brush 12 may be suitable for closing a bottle 10 containing the fixing agent. For example, this gripping area comprises an internal thread able to cooperate with an external thread made on a neck of bottle 10. The fixing agent may also be applied by means of an application element, particularly a flocked application element, or any other type of application element suitable for the application of a liquid fixing agent onto a nail, particularly a silicone spatula or a spatula of flexible plastic.

Application of fixing agent 7 is advantageously carried out in a conventional manner, such as when using nail polish, for example.

Here, in a noteworthy manner, fixing agent 7 comprises at least one pressure-sensitive adhesive polymer 14 and at least one solvent 15.

For example, the fixing agent may comprise at least one among the following products:
DOW CORNING® MG-2402 SILICONE ADHESIVE; and/or
DOW CORNING® BIO-PSA 7-4602 SILICONE ADHESIVE.

The DOW CORNING® MG-2402 SILICONE ADHESIVE product comprises, in percentage by weight, between 30% (inclusive) and 50% (exclusive) ethyl acetate. This is a colorless or pale-yellow product. It has a density of 1.02. The dynamic viscosity of this product is 4000 mPa·s. The viscosity of this product at 25° C. is about 2500 cP. The product has a peel adhesion of approximately 700 g/cm.

The DOW CORNING® BIO-PSA 7-4602 SILICONE ADHESIVE product comprises, in percentage by weight, between 25% (inclusive) and 55% (inclusive) ethyl acetate. This product also comprises xylene and ethylbenzene. This is a colorless or pale-yellow product. It has a density of 1.02. The dynamic viscosity of this product is 3,000 mPa·s.

The solvent used may contain, or be, XIAMETER® PMX-200 SILICONE FLUID 0.65 CS. This product is colorless. It comprises 100% by weight of hexamethyldisiloxane. It has a density of 0.76. The kinematic viscosity of this product is equal to 0.65 mm²/s at 25° C.

The total amount of solvent 15 in fixing agent 7 may be chosen to be relatively high, to enable the pressure-sensitive adhesive polymer(s) 14 to be spread over the entire surface of nail 9. However, too much solvent 15 reduces the amount of pressure-sensitive adhesive polymers 14, thereby limiting the adhesiveness or tack of fixing agent 7.

Advantageously, fixing agent 7 is chosen according to its tack and drying speed, i.e., the evaporation speed of the solvent(s) 15 that it comprises. Fixing agent 7 is more effective when its tack is high. However, fixing agent 7 must have a sufficiently long drying time, to enable easy application onto the nail. Also, the drying time of the fixing agent must be limited to enable decorative layer 3 to be attached to the nail, if possible without having to wait between the application on the nail and the transfer of decorative layer 3. In fact, as long as fixing agent 7 has not dried, it does not present satisfactory adhesiveness, the pressure-sensitive polymeric materials 14 being “embedded” in the solvent(s) 15. However, if the solvent evaporates too quickly, it does not allow the pressure-sensitive adhesive polymers 14 to spread satisfactorily over the entire surface of the nail. Consequently, in a preferred manner, the drying time of fixing agent 7 is, at a temperature of 25° C. and at a pressure of 1 bar, equal to or greater than 0.1 s, preferably equal to or greater than 0.5 s, still more preferably equal to or greater than 1 s and/or equal to or less than 5 s, preferably equal to or less than 3 s, even more preferably equal to or less than 2 s.

Preferably, a thin and homogeneous layer of fixing agent 7 is applied to nail 9. It is therefore possible to transfer the decorative layer very quickly after applying the layer of fixing agent 7, preferably without imposing a drying time on the consumer for applying the decoration. The homogeneity of the layer of fixing agent 7 also contributes to a homogeneous transfer of the decorative layer onto the nail.

For example, this thin layer has a thickness equal to or greater than 25 μm, preferably equal to or greater than 30 μm and/or equal to or less than 75 μm, preferably equal to or less than 50 μm. The thickness of the layer of fixing agent 7 accelerates the drying of fixing agent 7 and the evaporation of solvent 15. It is better that solvent 15 evaporates quickly, in particular to limit the risk of the user applying article 1 onto nail 9 too early, subsequently preventing solvent 15 from evaporating. In such a situation, fixing agent 7 does not have its optimal fixing effect, which limits or even prevents adhesion of decorative layer 3 onto nail 9.

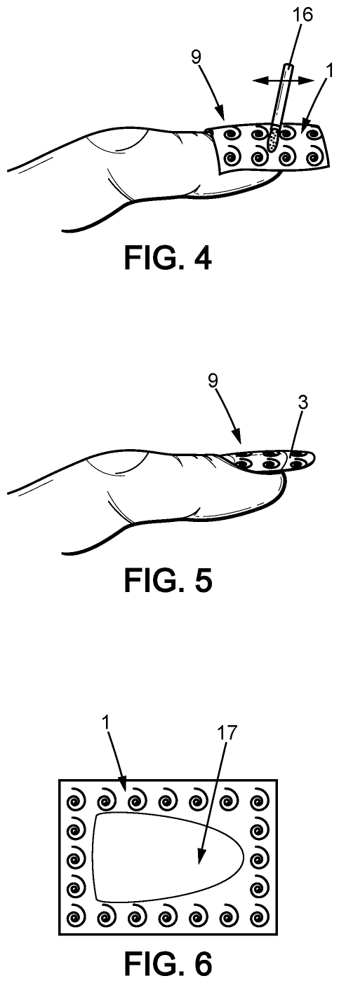

After solvent 15 has evaporated, article 1 is affixed to nail 9 and then pressure is applied to the surface of article 1 so as to transfer decorative layer 3 from article 1 onto nail 9. Preferably, pressure is applied to the article, over substantially the entire surface of nail 9. To do this, a dedicated utensil may be implemented. In the example illustrated in FIG. 4, an applicator 16 is used. Applicator 16 is, for example, an applicator of silicone or an applicator of plastic, preferably of flexible plastic. The applicator, particularly of plastic or silicone, may be flocked. A silicone applicator 16, relatively rigid but with a relatively soft contact surface with the article, does not risk damaging article 1 and, in particular, decorative layer 3. Applicator 16 enables article 1 to be smoothed over onto nail 9, causing decorative layer 3 to adhere, preferably only on the areas that were previously covered with fixing agent 7.

Smoothing it over with the use of applicator 16 also allows any air bubbles trapped between nail 9 and decorative layer 3 to escape.

It is noteworthy that when support film 4 has a different curvature than the curvature of the nail onto which article 1 is affixed, the smoothing over operation causes both decorative layer 3 to adhere to nail 9 and this same decorative layer 3 to detach from support layer 4, at the same time. It is therefore possible to easily identify that all of nail 9 was covered by decorative layer 3, as illustrated in FIG. 5. In fact, in this case, support layer 4 detaches naturally, by elasticity, from decorative layer 3, once it has been transferred onto nail 9.

Alternatively, once decorative layer 3 has been transferred, the user removes article 1 from the top of nail 9.

In both cases, only portion 17 of decorative layer 3 corresponding to the shape of nail 9, that is, the area where the fixing agent was applied, is removed from support film 4 of article 1, as seen in FIG. 6. Decorative layer 3 is thus only transferred from a portion of article 1. A same article 1 may thus advantageously be used to decorate several nails, by transferring different portions from decorative layer 3.

In certain cases, it may be necessary to do some retouching, particularly when decorative layer 3 was not transferred uniformly onto the surface of nail 9. In this case, the steps for applying article 1 may be repeated, with or without a new application of fixing agent onto the areas where decorative layer 3 was not transferred satisfactorily. Of course, such retouches are to be avoided when the decorative element has one or more patterns.

Also, it is possible to stack several decorative layers, of a same article or of different articles, to obtain a final nail decoration that is more complex.

The inventors tested many fixing agent 7 compositions. The best results were obtained by using a fixing agent 7 comprising:
40 to 70% by weight, preferably 50 to 60% by weight, of the DOW

CORNING® MG-2402 SILICONE ADHESIVE product;
1 to 15% by weight of the DOW CORNING® BIO-PSA 7-4602 SILICONE

ADHESIVE product; and
q.s. solvent for 100% by weight, particularly XIAMETER® PMX-200 SILICONE FLUID 0.65 CS.

The table below illustrates some of the composition samples of fixing agent 7, tested by the inventors:

| | DOW | DOW | Solvent | |
|---|---|---|---|---|
| | CORNING ® | CORNING ® | (XIAMETER ® | |
| | MG-2402 | BIO-PSA 7-4602 | PMX-200 | |
| | SILICONE | SILICONE | SILICONE | |
| | ADHESIVE | ADHESIVE | FLUID 0.65 CS) | |
| No. | [% weight] | [% weight] | [% weight] | Comments |
| 1 | 45 | 18 | 36 | Unsatisfactory transfer and ease of |
| | | | | use |
| 2 | 50 | 16.6 | 33.4 | Unsatisfactory transfer and ease of |
| | | | | use. |
| 3 | 52.6 | 8.8 | 38.6 | Unsatisfactory transfer and ease of |
| | | | | use. |
| 4 | 54.5 | 9 | 36.4 | Very satisfactory transfer and ease |
| | | | | of use |
| 5 | 52 | 8 | 40 | Very satisfactory transfer and ease |
| | | | | of use |
| 6 | 53 | 9 | 38 | Satisfactory transfer and ease of |
| | | | | use |
| 7 | 53 | 10 | 37 | Satisfactory transfer and ease of |
| | | | | use |
| 8 | 54 | 7 | 39 | Very satisfactory transfer and ease |
| | | | | of use |
| 9 | 58 | 3 | 39 | Satisfactory transfer and ease of |
| | | | | use |
| 10 | 60 | 4 | 36 | Very satisfactory transfer and ease |
| | | | | of use |
| 11 | 62 | 3 | 35 | Satisfactory transfer and ease of |
| | | | | use |
| 12 | 64 | 3 | 33 | Satisfactory transfer and ease of |
| | | | | use |
| 13 | 22.2 | 22.2 | 55.6 | Unsatisfactory transfer and ease of |
| | | | | use. |
| 14 | 20 | 20 | 60 | Unsatisfactory transfer and ease of |
| | | | | use. |
| 15 | 16.7 | 16.7 | 66.6 | Unsatisfactory transfer and ease of |
| | | | | use. |
| 16 | 30 | 30 | 40 | Unsatisfactory transfer and ease of |
| | | | | use. |
| 17 | 33.3 | 33.3 | 33.4 | Unsatisfactory transfer and ease of |
| | | | | use. |
| 18 | 37.5 | 37.5 | 25 | Unsatisfactory transfer and ease of |
| | | | | use. |
| 19 | 40 | 20 | 40 | Unsatisfactory transfer and ease of |
| | | | | use. |
| 20 | 50 | 10 | 40 | Satisfactory transfer and ease of |
| | | | | use |
| 21 | 60 | 0 | 40 | Unsatisfactory transfer and ease of |
| | | | | use. |
| 22 | 20 | 40 | 40 | Unsatisfactory transfer and ease of |
| | | | | use. |
| 23 | 10 | 50 | 40 | Unsatisfactory transfer and ease of |
| | | | | use. |
| 24 | 0 | 60 | 40 | Unsatisfactory transfer and ease of |
| | | | | use. |

The best transfers of decorative layer 3 onto a nail are obtained for compositions comprising a mixture of DOW CORNING® MG-2402 SILICONE ADHESIVE and DOW CORNING® BIO-PSA 7-4602 SILICONE ADHESIVE. In particular, when these mixtures are such that the mass ratio between the amount of DOW CORNING® MG-2402 SILICONE ADHESIVE to the amount of DOW CORNING® BIO-PSA 7-4602 SILICONE ADHESIVE is equal to or greater than 0.3, preferably equal to or greater than 1, particularly between 2.5 and 3.5, then the fixing agent has a particularly high tack, quite suitable for the desired application. Removal consisting of removing the portion of decorative layer 3 of article 1 transferred to the skin, lips or at least one nail 9 may advantageously be carried out by using a conventional remover. In particular, on a nail, a conventional dissolver may be used, as when removing nail polish.

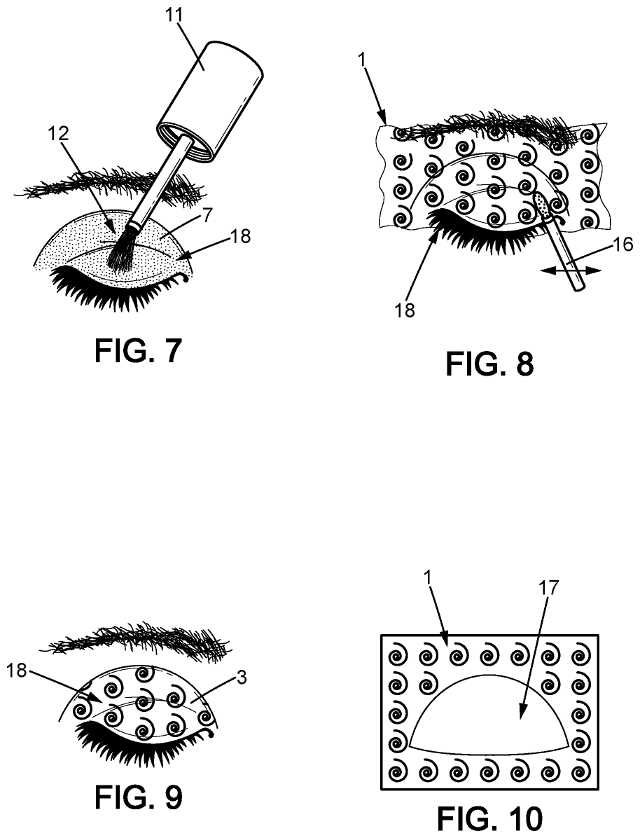

FIGS. 7 to 10 illustrate the application of article 1 as described above, onto a person's eyelid 18.

This application is carried out in roughly the same manner as the above application onto a nail.

First, the user applies fixing agent 7 onto eyelid 18. The solvent of fixing agent 7 is allowed to evaporate and then article 1 is affixed to eyelid 18. Lastly, pressure is applied to article 1, for example by smoothing it over using an applicator 16. Article 1 is then removed, of which part of decorative layer 3 remains adhered to eyelid 18. An article 1 with an impression 17 of eyelid 18 is thus obtained. Alternatively, article 1 is removed simply by applying pressure to article 1, particularly when the support film has a different curvature than the curvature of the eyelid.

As above, decorative layer 3 may be used for decorating eyelid 18. In this case, decorative layer 3 can advantageously replace eye shadow. Alternatively or in addition, decorative layer 3 may have a covering effect, enabling an imperfection in the skin of the eyelids or the skin around the eyes, for example, to be concealed. In this case, in particular, decorative layer 3 may have a natural effect, i.e., may be an imitation of the natural color of eyelid 18 in the absence of makeup.

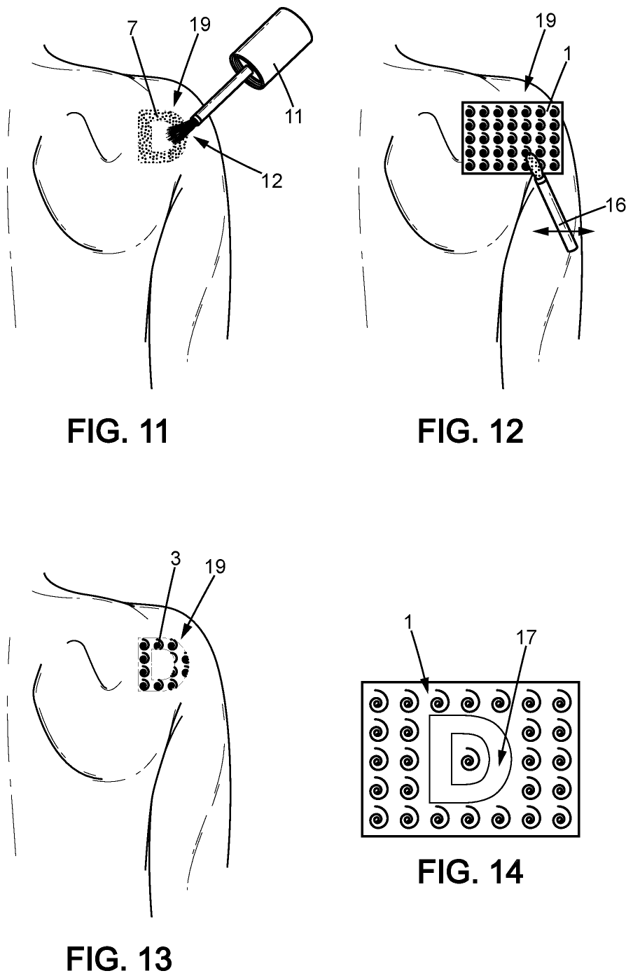

FIGS. 11 to 14 illustrate the application of article 1 as described above, onto a person's shoulder 19.

This application is carried out in substantially the same manner as the previous application onto a nail and an eyelid.

First, the user applies fixing agent 7 onto the skin of shoulder 19. Here, by way of example, this fixing agent 7 is applied in a pattern, in this particular case a “D”-shaped pattern. Of course, this shape of the pattern of the fixing agent application is in no way limiting. This shape only illustrates one of the many embodiments of the use of article 1 that are accessible to users.

The solvent of fixing agent 7 is allowed to evaporate and then article 1 is affixed to the skin of shoulder 19. Lastly, pressure is applied to article 1, for example by smoothing it over with an applicator 16. Article 1 is then removed, of which part of decorative layer 3 remains adhered to the skin of shoulder 19, in the pattern of the application of fixing agent 7. An article 1 with an impression 17 of the part of the decorative layer transferred to shoulder 19 is thus obtained. Alternatively, article 1 is removed simply by applying pressure to article 1, particularly when the support film has a different curvature than the curvature of shoulder 19.

As above, decorative layer 3 can be used for decorating shoulder 19. In this case, the decorative layer can advantageously replace a permanent or temporary tattoo, for example in henna. Alternatively or in addition, decorative layer 3 may have a skin-covering effect, enabling an imperfection in the skin or a tattoo to be concealed. In this case, decorative layer 3 may be an imitation of the natural color of the skin of shoulder 19.

The present invention is not limited to the examples described above; on the contrary, the invention is suitable for many variations accessible to the person skilled in the art.

In the examples presented, article 1 is applied to a nail, an eyelid or a shoulder. However, it is understood that the article can be applied to other parts of a person's body, in general to the person's skin.

1. An article for decorating a person's skin, lips or nail, comprising at least one decorative element to be transferred to the skin, lips or at least one nail of a person by means of a fixing agent comprising at least one pressure-sensitive adhesive polymer and at least one solvent, the article comprising:
a decorative layer to be at least partially transferred to a person's skin, lips or nail, said decorative layer comprising said at least one decorative element, said decorative layer having a first external surface and a second external surface,
a support film of said decorative layer, said support film being removably fixed to the first external surface of said decorative layer,
a base layer forming a barrier for limiting or even preventing migration of the at least one pressure-sensitive adhesive polymer, said base layer being resistant to said at least one solvent.

2. The article according to claim 1, comprising a separation layer between the decorative layer and the support film, said separation layer being intended to enable the separation of the decorative layer and the support film, once the decorative layer has been transferred to a person's skin, lips or at least one nail, by means of said fixing agent.

3. The article according to claim 1, wherein said base layer comprises at least SiO2 and an acrylic resin.

4. The article according to claim 1 wherein the decorative layer comprises several superimposed sublayers.

5. The article according to claim 4, wherein the decorative layer comprises at least one metallic layer.

6. The article according to claim 4, wherein the decorative layer comprises at least one layer of acrylate copolymer and of colored pigments or of pearlescent powder or a decorative layer with a metallic effect.

7. The article according to claim 1, wherein the support film is curved.

8. The article according to claim 1 wherein the support film is flat.

9. The article according to claim 1 wherein the support film is transparent, translucent or opaque.

10. The article according to claim 1 wherein the decorative element comprises at least one among a pattern in two or three dimensions, or an effect imitating three dimensions, or imitating a fabric, a particle effect, a metal, or a decoration providing Optical illusions according to its orientation relative to a light source.

11. The article according to claim 1 wherein only a portion of the decorative layer is intended to be transferred to a person's skin, lips or at least one nail, to the location where the fixing agent has been applied beforehand.

12. The article according to claim 1 wherein the thickness of the base layer is less than 20 μm.

13. A fixing agent for transferring the decorative layer of an article according to claim 1 onto a person's skin, lips or nail, comprising at least one pressure-sensitive adhesive polymer and at least one solvent.

14. The fixing agent according to claim 13, comprising at least one among the following products:
DOW CORNING® MG-2402 SILICONE ADHESIVE; or
DOW CORNING® BIO-PSA 7-4602 SILICONE ADHESIVE.

15. The fixing agent according to claim 14, comprising, in percentages by weight:
40 to 70% DOW CORNING® MG-2402 SILICONE ADHESIVE;
1 to 15% DOW CORNING® BIO-PSA 7-4602 SILICONE ADHESIVE; and
q.s. solvent to 100%.

16. The fixing agent according to claim 15, comprising, in percentages by weight:
50 to 60% DOW CORNING® MG-2402 SILICONE ADHESIVE;
4 to 9% DOW CORNING® BIO-PSA 7-4602 SILICONE ADHESIVE; and
q.s. solvent to 100%.

17. The fixing agent according to claim 16, comprising, in percentages by weight:
54.5% DOW CORNING® MG-2402 SILICONE ADHESIVE;
9% DOW CORNING® BIO-PSA 7-4602 SILICONE ADHESIVE; and
36.4% solvent.

18. The fixing agent according to claim 16, comprising, in percentages by weight:
52% DOW CORNING® MG-2402 SILICONE ADHESIVE;
8% DOW CORNING® BIO-PSA 7-4602 SILICONE ADHESIVE; and
40% solvent.

19. The fixing agent according to claim 16, comprising, in percentages by weight:
54% DOW CORNING® MG-2402 SILICONE ADHESIVE;
7% DOW CORNING® BIO-PSA 7-4602 SILICONE ADHESIVE; and
39% solvent.

20. The fixing agent according to claim 16, comprising, in percentages by weight:
60% DOW CORNING® MG-2402 SILICONE ADHESIVE;
4% DOW CORNING® BIO-PSA 7-4602 SILICONE ADHESIVE; and
36% solvent.

21. The fixing agent according to claim 13 wherein the solvent contains XIAMETER® PMX-200 SILICONE FLUID 0.65 CS.

22. A kit for decorating a person's skin, lips or nail, comprising at least one article according to claim 1 and at least one container containing a fixing agent, the fixing agent.

23. The decorating kit according to claim 22, also comprising a fixing agent application element, for example a brush.

24. The decorating kit according to claim 22, also comprising an applicator capable of smoothing over said at least one article onto a person's skin, lips or nail.

25. A method of decorating a person's nail, skin or lips, by means of an article for decorating a person's skin, lips or nail, comprising at least one decorative element to be transferred to the skin, lips or at least one nail of a person by means of a fixing agent comprising at least one pressure-sensitive adhesive polymer and at least one solvent, the article comprising:
a decorative layer to be at least partially transferred to a person's skin, lips or nail, said decorative layer comprising said at least one decorative element, said decorative layer having a first external surface and a second external surface,
a support film of said decorative layer, said support film being removably fixed to the first external surface of said decorative layer,
a base layer forming a barrier for limiting migration of the at least one pressure-sensitive adhesive polymer, said base layer being resistant to said at least one solvent,
the method comprising steps consisting of:
i) Applying a layer of said fixing agent onto the part to be decorated;
ii) Allowing the at least one solvent's of the fixing agent to evaporate;
iii) Affixing the article onto the part to be decorated;
iv) Applying pressure on the article; and
v) Removing the support film from the article.

26. The method according to claim 25, wherein, in step i), a layer of fixing agent with a thickness equal to or greater than 25 μm and less than 75 μm is applied.

27. The method according to claim 25, wherein step i) is carried out by means of an application element.

28. The method according to claim 25, wherein, in step iv), the article is smoothed over.

29. The method according to claim 25, wherein, in step v), only a portion of the decorative layer is transferred, where a layer of fixing agent has previously been applied in step i).
